(19) United States
(12) Patent Application Publication
(10) Pub. No.: US 2009/0245175 A1
(43) Pub. Date: Oct. 1, 2009

(54) MOBILE RADIO TERMINAL

(75) Inventor: Makoto KOBAYASHI, Tachikawa-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/406,386

(22) Filed: Mar. 18, 2009

(30) Foreign Application Priority Data
Mar. 25, 2008 (JP) 2008-078865

(51) Int. Cl. H04W 4/00

(52) U.S. Cl. 370/328

(57) ABSTRACT

A mobile radio terminal has a first radio communication unit and a second radio communication unit adopting mutually different communication systems, first starts the first radio communication unit and connects to a content server CS, obtains meta-data of a desired content, and a control unit determines a communication system to be applied to downloading on the basis of the meta-data, and downloads the content data with one of the first radio communication unit and that second radio communication unit that corresponds to the determination.

### CROSS-REFERENCE TO RELATED APPLICATIONS

This application is based upon and claims the benefit of priority from prior Japanese Patent Application No. 2008-078865, filed Mar. 25, 2008, the entire contents of which are incorporated herein by reference.

### BACKGROUND OF THE INVENTION

1. Field of the Invention

The present invention relates to a mobile radio terminal capable of executing communications by two communication means.

2. Description of the Related Art

As is known, a mobile radio terminal such as a cellular telephone has been capable of receiving streaming data and downloading content data of large file size, i.e. receiving data of large size, besides communication functions such as conventional speech communications, transmission and reception of emails, web browsing and the like.

As for a communication method, a circuit switching bearer which is charged in accordance with a use time and a packet-switching bearer which is charged in accordance with a data amount can be selected. For this reason, for example, the size of a target file is detected and a bearer is selected by a carrier in accordance with the detection result before downloading a file (see, for example, Jpn. Pat. Appln. KOKAI Publication No. 2007-082251).

In the conventional manner, however, the carrier needs to recognize that the mobile radio terminal has the circuit switching bearer and the packet-switching bearer as the communication ability. In addition, another problem arises that since the barer is selected y the carrier, communications are not necessarily executed by a bearer desired by a user.

There is a conventional problem that selection of the desired bearer cannot be executed unless the carrier recognizes the communication ability of the mobile radio terminal.

### BRIEF SUMMARY OF THE INVENTION

The present invention has been accomplished to solve the above-described problems. The object of the present invention is to provide a mobile radio terminal capable of executing communications by a bearer desired by a user even if a carrier does not recognize a communication ability of the mobile radio terminal.

To achieve this object, an aspect of the present invention is a mobile radio terminal comprising: a first communication unit which makes communications with a content server over the first network; a second communication unit which makes communications with a content server over the second network; an attribute data obtaining unit which controls the first communication unit and obtains attribute data relating to a content from the content server; and a download control unit which controls one of the first communication unit and the second communication unit to download the content from the content server, in accordance with the attribute data obtained by the attribute data obtaining unit.

As described above, the present invention comprises two communication means making communications over different networks, obtains attribute data relating to a content by one of the communication means, and then controls one of the two communication means on the basis of the attribute data to download the content from the content server.

Therefore, the present invention can provide a mobile radio terminal capable of executing communications by a bearer desired by a user even if a carrier does not recognize a communication ability of the mobile radio terminal.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a configuration of a mobile radio terminal according to an embodiment of the present invention;

FIG. 2 is a flowchart showing operations of the mobile radio terminal shown in FIG. 1 at the time of downloading contents; and

FIG. 3 is a sequence diagram showing operations of the mobile radio terminal shown in FIG. 1 at the time of downloading contents.

### DETAILED DESCRIPTION OF THE INVENTION

An embodiment of the present invention will be described with reference to the accompanying drawings.

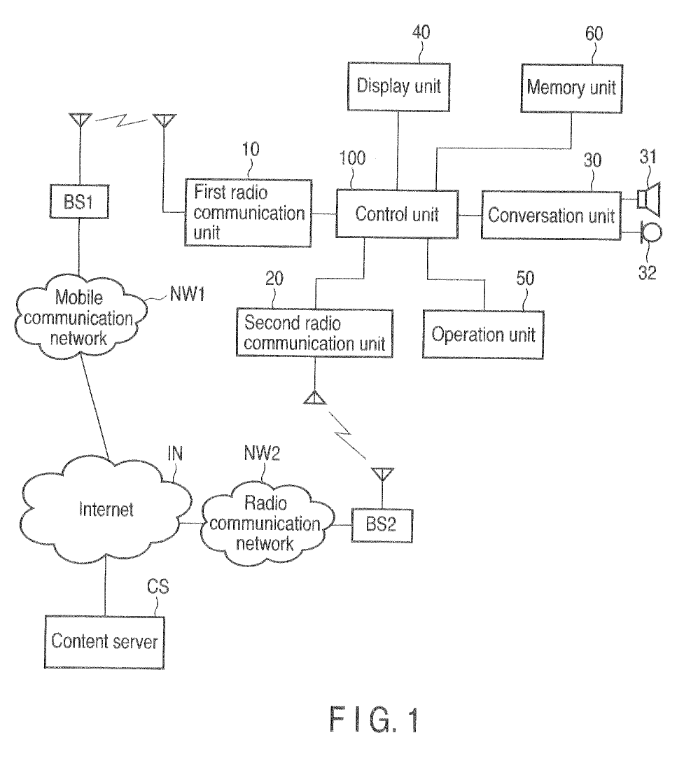

FIG. 1 shows a block diagram showing a configuration of a mobile radio terminal according to an embodiment of the present invention. The mobile radio terminal comprises, as its main constituent elements, a control unit 100, a first radio communication unit 10, a second radio communication unit 20, a conversation unit 30, a display unit 40, an operation unit 50 and a memory unit 60 as shown in FIG. 1.

The first radio communication unit 10 is a radio communication unit based on the radio communication standards employed in the mobile communication system such as W-CDMA (Wideband Code Division Multiple Access), and establishes radio communications with a base station apparatus BS1 accommodated in a mobile communication network NW1 to transmit and receive speech data, electronic mail data and the like and receive Web data, streaming data and the like, under instructions of the control unit 100. In other words, the mobile communication network NW1 and the base station apparatus BS1 accommodated therein are components of the cellular telephone system.

The second radio communication unit 20 is a radio communication unit based on the radio communication standards such as wireless LAN communication of IEEE 802.11a, b, g, n or the like, mobile WiMAX (Worldwide Interoperability for Microwave Access) and the like, and establishes radio communications with a base station apparatus BS2 accommodated in a radio communication network NW2 to execute various types of data communications, under instructions of the control unit 100. In other words, the radio communication network NW2 and the base station apparatus BS2 accommodated therein are components of the wireless LAN system or mobile WIMAX system.

The second radio communication unit 20 may not be initially built, but may be arbitrarily added via an external interface (not shown) of the mobile radio terminal by the user. For example, the mobile radio terminal comprises a USB (Universal Serial Bus) terminal as an external interface, and a communication function is added by additionally connecting the second radio communication unit 20 by the USB connection.

In the following descriptions, the communication employing the first radio communication unit 10 is called first system and the communication employing the second radio communication unit 20 is called second system. In the first system, the communication is charged in accordance with a data amount, for example, 1 dollar per 100 kbyte at an effective speed of 384 kbps. In the second system, for example, the communication is charged for a fixed fare, for example 10 dollars per month at an effective speed of 20 kbps.

The mobile communication network NW1 and the radio communication network NW2 are connected to the Internet IN. A content server CS provides various types of content data in accordance with user requests via the Internet IN.

The conversation unit 30 is connected with a speaker 31 and a microphone 32 to convert user's speech input through the microphone 32 into speech data and output the speech data to the control unit 100, and decode speech data received from a conversation partner and output the decoded speech data from the speaker 31.

The display unit 40 displays images (still images and moving images), character information and the like under control of the control unit 100, to transmit the information visually to the user.

The operation unit 50 comprises a plurality of key switches and the like and accepts instructions from the user by means of the key switches and the like.

The memory unit 60 stores control programs and control data of the control unit 100, application software, address data associated with names, telephone numbers and the like of the communication partners, data of transmitted and received electronic mails, Web data downloaded by Web browsing, downloaded streaming data, and the like.

The control unit 100 comprises a microprocessor, executes operations based on the control programs and the control data stored in the memory unit 60, controls each of the units in the mobile radio terminal, and implements speech communications and data communications. The control unit 100 also comprises a communication controlling function of executing operations based on the application software stored in the memory unit 60, displaying the moving images on the display unit 40 on the basis of transmission and reception of electronic mails, Web browsing and the downloaded streaming data, and executing speech communications.

In addition, the control unit 100 comprises a control function of controlling the first radio communication unit 10 or the second radio communication unit 20 to execute communications with the content server CS over the Internet IN, download content data and display the downloaded content data on the display unit 40, and output music and the like from a speaker (not shown). Further, the control unit 100 comprises a control function of changing the communication means (first radio communication unit 10 or the second radio communication unit 20) to be employed, in accordance with data of target when content data are downloaded from the content server CS.

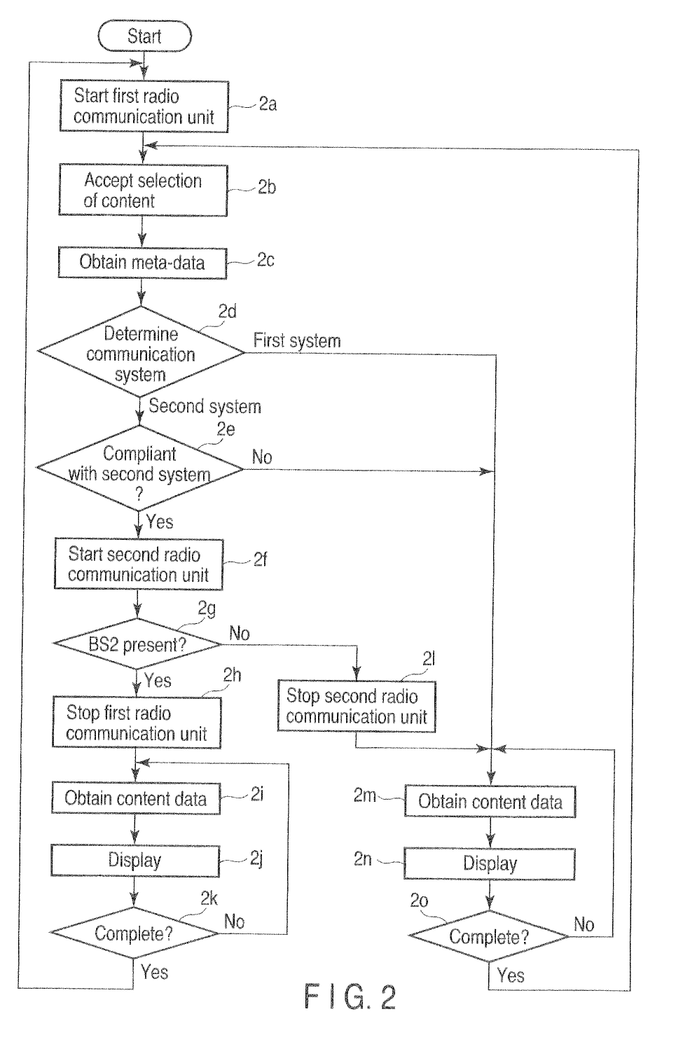

Next, operations of the mobile radio terminal having the above-described configuration are explained. Operations of downloading the content data are particularly explained. FIG. 2 is a flowchart showing a control flow of the operations executed by the control unit 100. If the user inputs a request for connection to the content server CS with the operation unit 50, the operations are started and repeated until a request for ending the operations is transmitted from the user.

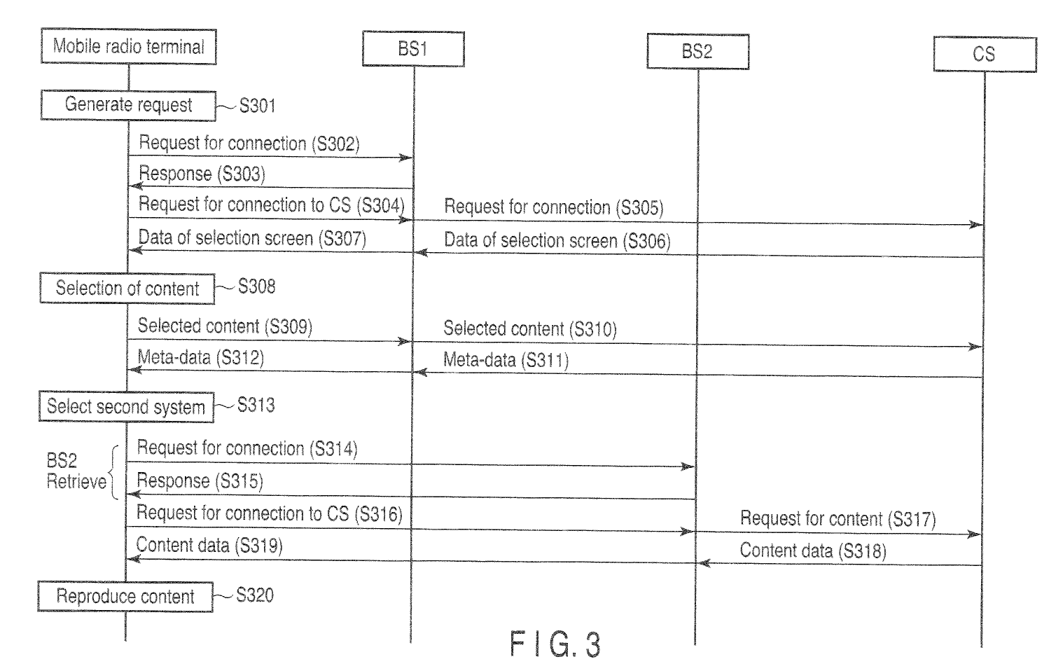

The control unit 100 executes processing of the control flow by executing operations based on the control programs and the control data stored in the memory unit 60. A sequence of communications executed among the mobile radio terminal, the base station apparatus BS1, the base station apparatus BS2 and the content server SC is illustrated in FIG. 3.

First, the control unit 100 activates the first radio communication unit 10 in response to the request from the user (sequence S301) and directs the first radio communication unit 10 to start connection to the content server CS, in step 2a, and shifts to step 2b. The first radio communication unit 10 receiving the direction from the control unit 100 establishes a radio link with the base station apparatus BS1 by radio communication in predetermined procedures (sequences S302, S303) and connects to the content server CS over the radio link and the mobile communication network NW1 (sequences S304, S305). Then, the first radio communication unit 10 obtains data of a Web page to accept selection of the content from the content server CS (sequences S306, S307). On the basis of the data, the control unit 100 displays the Web page on the display unit 40.

In step 2b, the control unit 100 accepts a request for selection of content data desired by the user, through the operation unit 50 (sequence S308). The control unit 100 controls the first radio communication unit 10 to transmit the request for selection to the content server CS, and shifts to step 2c. The first radio communication unit 10 transmits identification information of the content selected by the user to the content server CS via the base station apparatus BS1 (sequences S309, S310).

The content server CS transmits meta-data of the selected content to the mobile radio terminal via the base station apparatus BS1 (sequences S311, S312). The meta-data includes attribute data of a content such as content name (for example, “Soccer Digest”), type of moving image data (for example, real-time transfer moving image), play time (for example, 10 minutes), through-put (for example, 3 Mbps), total size (for example, 225 Mbyte), data format (for example, MUX: MPEG-2TS, Audio MPEG-4 AAC, Video H264), image size (for example, 640×480) and the like.

The control unit 100 obtains the meta-data through the first radio communication unit 10 in step 2c, and shifts to step 2d.

In step 2d, the control unit 100 determines a communication system employed to download the content accepted in step 2b, on the basis of the meta-data (sequence S313). Information for determining the communication system is preliminarily stored in the memory unit 60.

For example, if the control unit 100 detects from the meta-data that the data size of the content is smaller than a preset threshold value, the control unit 100 determines employment of the first system. If the control unit 100 detects that the data size of the content is equal to or greater than the preset threshold value, the control unit 100 determines employment of the second system.

Otherwise, the control unit 100 detects information representing the type of the content data from the meta-data and discriminates from the information whether or not real-time communication is necessary. If the real-time communication is necessary, the control unit 100 determines employment of the first system. If the content data is temporarily stored in the memory unit 60 and reproduced, the real-time communication is not necessary. In this case, the control unit 100 determines employment of the second system.

Otherwise, the control unit 100 may detect the real-time communication from the meta-data, detect a through-put requested in the real-time communication, and employ a system satisfying the requirement. The control unit 100 may execute a predetermined operation process using the information included in the meta-data, and determine the communication system which meets a priority (communication time, cost, power consumption) set through the operation unit 50 by the user.

If the control unit 100 determines employment of the first system, the control unit 100 shifts to step 2m. If the control unit 100 determines employment of the second system, the control unit 100 shifts to step 2e. FIG. 3 illustrates a case where the control unit 100 employment of the second system in sequence S313.

In step 2e, the control unit 100 discriminates whether or not the mobile radio terminal comprises communication means of the second system (sequence S313). If the mobile radio terminal comprises the communication means of the second system, the control unit 100 shifts to step 2f. If the mobile radio terminal does not comprise the communication means of the second system, the control unit 100 shifts to step 2m. In FIG. 1, the mobile radio terminal comprises the communication means of the second system and the control unit 100 shifts to step 2f. In FIG. 3, the control unit 100 confirms presence of the communication means of the second system (second radio communication unit 20) in sequence S313.

In step 2f, the control unit 100 starts the second radio communication unit 20 and directs the second radio communication unit 20 to start the connection to the content server CS, and shifts to step 2g. The second radio communication unit 20 receiving the direction from the control unit 100 starts retrieving the base station apparatus BS2 in predetermined procedures (sequence S313). In other words, the second radio communication unit 20 attempts receiving a pilot signal which is periodically transmitted from the base station apparatus BS2.

In step 2g, the control unit 100 confirms presence of the base station apparatus BS2 by discriminating whether nor not the second radio communication unit 20 has been able to receive the pilot signal from the base station apparatus BS2 (sequence S313). If the control unit 100 successfully confirms the presence of the base station apparatus BS2, the control unit 100 shifts to step 2h. If the control unit 100 fails to confirm the presence of the base station apparatus BS2, the control unit 100 shifts to step 2l.

The control unit 100 stops energizing the second radio communication unit 20 in step 2h, and shifts to step 2i (sequence S313). In other words, the control unit 100 turns off the power supply of the first radio communication unit 10.

In step 2i, the control unit 100 controls the second radio communication unit 20 to start downloading the content of the content server CS, and shifts to step 2j. More specifically, the second radio communication unit 20 receiving the direction from the control unit 100 establishes a radio link by executing radio communications with the base station apparatus BS2 in predetermined procedures (sequences S314, S315).

The second radio communication unit 20 requests the content server CS for the content over the radio link and the radio communication network NW2 (sequences S316, S317). The content server CS transmits the content data to the mobile radio terminal via the base station apparatus BS2, and the second radio communication unit 20 receives the transmitted content data (sequences S318, S319).

The control unit 100 starts processes of displaying a moving image based on the content data downloaded in step 2i and outputting music and the like based on the content data from a speaker (not shown) in step 2j (sequence S320), and shifts to step 2k.

In step 2k, the control unit 100 discriminates whether or not reproduction of the content is completed. If the reproduction of the content is ended, the control unit 100 shifts to step 2a. If the reproduction of the content is not ended, the control unit 100 shifts to step 2i and continues downloading the content data.

On the other hand, the content data are downloaded in the first system in steps 2l to 2o. The sequences are not shown in FIG. 3.

The control unit 100 stops energizing the second radio communication unit 20 in step 2l, and shifts step 2m. In other words, the control unit 100 turns off the power supply of the second radio communication unit 20.

The control unit 100 controls the first radio communication unit 10 to start downloading the content from the content server CS in step 2m, and shifts to step 2n. More specifically, the first radio communication unit 10 receiving the direction from the control unit 100 requests the content server CS for the content over the radio link with the base station apparatus BS2 and the mobile communication network NW1. The content server CS transmits the content data to the mobile radio terminal via the base station apparatus BS1 and the first radio communication unit 10 receives the content data.

The control unit 100 starts processes of displaying a moving image based on the content data downloaded in step 2n on the display unit 40 and outputting music and the like based on the content data from a speaker (not shown) in step 2n, and shifts to step 2o.

In step 2o, the control unit 100 discriminates whether or not reproduction of the content is completed. If the reproduction of the content is ended, the control unit 100 shifts to step 2b. If the reproduction of the content is not ended, the control unit 100 shifts to step 2m and continues downloading the content data.

As described above, the mobile radio terminal having the above-described configuration comprises the first radio communication unit 10 and the second radio communication unit 20 employing mutually different communication systems, starts the first radio communication unit 10 and connects the first radio communication unit 10 to the content server CS, and obtains meta-data of the selected content. The control unit 100 determines the communication system which should be applied to downloading on the basis of the meta-data, and downloads the content data with the communication system which corresponds to the determination, of the first radio communication unit 10 and the second radio communication unit 20.

Therefore, since the communication system is not determined by the carrier, the mobile radio terminal can execute communications by the suitable bearer even if the carrier does not recognize the communication ability of the mobile radio terminal.

In addition, of the two communication means (first radio communication unit 10 and second radio communication unit 20), one communication means (first radio communication unit 10) is generally operated and the other communication means (second radio communication unit 20) is operated as needed, to search the base station apparatus BS2. Therefore, even if the mobile radio terminal comprises the two communication means, each of them does not search the base station. In addition, the power consumption can be restricted, because the electricity to the communication system which is not employed is cut at the downloading.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

For example, W-CDMA, wireless LAN or WiMAX has been exemplified in the above-described embodiment, but the present invention is not limited to this.

In step 2d, the communication system is determined on the basis of the meta-data, under the discrimination conditions pre-stored in the memory unit 60. Instead of this, for example, in step 2d, the user may be asked of the desired communication system through the display unit 40, the selection of the communication system may be accepted from the user through the operation unit 50 and the accepted communication system may be adopted.

The present invention can also be variously modified within a scope which does not depart from the gist of the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A mobile radio terminal comprising:
a first communication unit which makes communications with a content server over the first network;
a second communication unit which makes communications with a content server over the second network;
an attribute data obtaining unit which controls the first communication unit and obtains attribute data relating to a content from the content server; and
a download control unit which controls one of the first communication unit and the second communication unit to download the content from the content server, in accordance with the attribute data obtained by the attribute data obtaining unit.

2. The mobile radio terminal according to claim 1, further comprising a stop control unit which stops an operation of one of the first communication unit and the second communication unit that is not employed for downloading.

3. The mobile radio terminal according to claim 1, wherein in accordance with information indicating whether or not real-time communication is required included in the attribute data, the download control unit controls one of the first communication unit and the second communication unit and downloads the content from the content server.

4. The mobile radio terminal according to claim 1, wherein in accordance with information indicating a through-put included in the attribute data, the download control unit controls one of the first communication unit and the second communication unit and downloads the content from the content server.

5. The mobile radio terminal according to claim 1, wherein in accordance with information indicating a data size of the content included in the attribute data, the download control unit controls one of the first communication unit and the second communication unit and downloads the content from the content server.
